(19) United States
(12) Patent Application Publication
(10) Pub. No.: US 2011/0166987 A1
(43) Pub. Date: Jul. 7, 2011

(54) Evaluating Loan Access Using Online Business Transaction Data

(75) Inventors: Xiaoming Hu, Hangzhou (CN); Feng Li, Hangzhou (CN); Xin Yu Peng, Hangzhou (CN); Jing Gao, Hangzhou (CN); Wei Yan Lu, Hangzhou (CN); Zhengwei Zhang, Hangzhou (CN); Jinyin Zhang, Hangzhou (CN); Jian Shi, Hangzhou (CN); Guo dong Fan, Hangzhou (CN)

(73) Assignee: Alibaba Group Holding Limited, Grand Cayman (KY)

(21) Appl. No.: 12/668,080

(22) PCT Filed: Sep. 28, 2009
(86) PCT No.: PCT/US09/58621

§ 371 Date: Jan. 7, 2010

(30) Foreign Application Priority Data
Sep. 28, 2008 (CN) 200810166967.1

(51) Int. Cl. G06Q 40/00

(52) U.S. Cl. 705/38

(57) ABSTRACT

A method and a loan access evaluation system use a loan applicant's actual business transaction information received from an online business system on which the loan applicant conducts business. In addition to the information of the loan applicant's owner, other general background business information and historical business information of the loan applicant, the method and the system obtain detailed transaction data of the loan applicant on e-commerce systems or platforms and banks, and thus have access to dynamic business data of the applicant for a more reliable loan access appraisal.

### RELATED APPLICATIONS

This application claims priority from Chinese patent application, Application No. 200810166967.1, filed Sep. 28, 2008, entitled “METHOD AND SYSTEM FOR LOAN ACCESS EVALUATION”.

### BACKGROUND

The present disclosure relates to the field of computer networking, and particularly relates to methods and systems for evaluating loan access.

Companies and individuals often need to borrow money from banks to maintain normal business operations. Bank loan services cater to this type of needs. A loan reviewer analyzes financial statements of a company or interview with the company before the bank decides whether a loan is disbursed to the company. This process is not only costly and time-consuming, but also unable to obtain accurate and comprehensive information related to the company in real time. This deficiency often increases loan risks, and makes it difficult to have fast and inexpensive expansion of a loan service. This is especially true when evaluating and risk-managing medium, small, and micro-sized companies, where the most important information such as operating activities and data of the companies is absent.

Because the existing loan review systems of the banks do not have access to a company's e-commerce application data, particularly activities and data on e-commerce websites or various transaction platforms, some critical information related to the key operation status of the company is absent during the loan review. This makes it difficult to achieve complete online automation, and hard to conduct comprehensive analysis and validation of the loan-receiving company.

Existing bank systems are not interconnected, making it difficult to obtain a company's detailed transaction data with another bank. It is also difficult to obtain a company's transaction data on an e-commerce platform that is not directly connected to the bank. Further, the existing bank review system cannot obtain real-time information such as company's data in a credit investigation system or an associated website. The existing bank loan services are also difficult to be quickly scaled because the information collection and review, as well as loan disbursement, rely on offline information input and paper document collection.

### SUMMARY OF THE DISCLOSURE

A method and a loan access evaluation system use the loan applicant's actual business transaction information received from an online business system on which the loan applicant conducts business. In addition to the applicant's general background business information and historical business information, the method and the system obtain detailed transaction data of the applicant on e-commerce systems or platforms and banks, and thus have access to dynamic business data of the applicant for a more reliable loan access appraisal.

One aspect of the disclosure is a method for evaluating loan access. The method establishes an electronic connection between a loan access evaluation system and at least one online business system on or through which a loan applicant conducts business. The loan access evaluation system receives business transaction information of the loan applicant from the online business system. The business transaction information contains information of actual business transactions conducted by the loan applicant on or through the online business system. The method analyzes the collected information of the loan applicant to generate an analysis result as a basis for determining whether the loan applicant satisfies a loan access requirement, where the analyzed collected information includes at least the received business transaction information of the loan applicant. The method then disburses a loan to the loan applicant if the loan requirement is satisfied.

In one embodiment, the online business system is externally connected to the loan access evaluation system. In another embodiment, the online business system is internally connected to the loan access evaluation system. The connected online business system may be one or more of an e-commerce website and a banking system.

Another aspect of the disclosure is a loan access evaluation system that includes an information collection interface, an information analyzer and a decision-making unit. The information collection interface establishes an electronic connection between the loan access evaluation system and at least one online business system on or through which a loan applicant conducts business. The information collection interface is operative for receiving business transaction information of the loan applicant from the online business system. The business transaction information contains information of actual business transactions conducted by the loan applicant on or through the online business system. The information analyzer analyzes collected information of the loan applicant to generate an analysis result as a basis for determining whether the loan applicant satisfies a loan access requirement. The collected information includes at least the received business transaction information of the loan applicant. The decision-making unit is adapted for disbursing a loan to the loan applicant if loan requirement is satisfied.

In one embodiment, the loan access evaluation system is implemented in a server computer system.

Compared with existing technologies, the exemplary embodiments of the present disclosure may have several advantages. By obtaining detailed transaction data of a company on c-commerce platforms and various banks, the loan access system not only have access to general business background information, but also dynamic business transaction data of the loan applicant. The loan access system also has access to the historical data of the company obtained from loan management systems and/or loan risk control systems. This allows a comprehensive analysis of the company. The loan process may be completed online, allowing fast, simple and inexpensive operations.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF DRAWINGS

The detailed description is described with reference to the accompanying figures. In the figures, the left-most digit of a reference number identifies the figure in which the reference number first appears. The use of the same reference numbers in different figures indicates similar or identical items.

FIG. 1 shows a flow chart of an exemplary method for evaluating loan access in accordance with the present disclosure.

FIG. 2 shows a diagram of an exemplary loan access the evaluation system in a network environment in accordance with the present disclosure.

FIG. 3 shows a diagram of an exemplary loan access evaluation system with further detail in accordance with the present disclosure.

### DETAILED DESCRIPTION

The exemplary embodiments of the present disclosure are described more clearly and completely below using the accompanying figures in the exemplary embodiments.

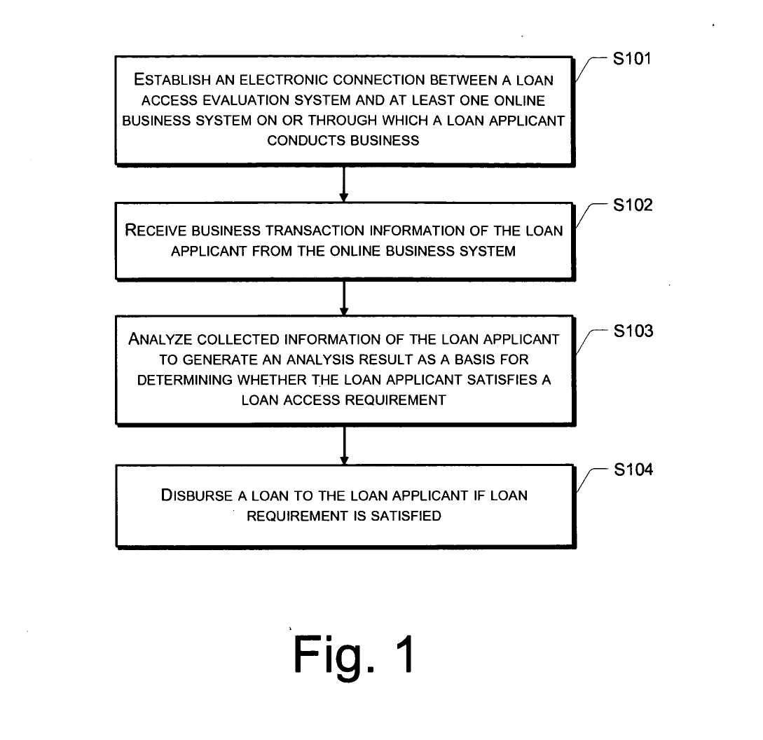

FIG. 1 is a flowchart of an exemplary process for evaluating loan access in accordance with the present disclosure. In this description, the order in which a process is described is not intended to be construed as a limitation, and any number of the described process blocks may be combined in any order to implement the method, or an alternate method. The exemplary process includes the procedures described as follows.

Block S101 established an electronic connection between a loan access evaluation system and at least one online business system on or through which a loan applicant conducts business. As will be shown below, the loan access evaluation system is computed based. The online business system connected to the loan access evaluation system may be one that is either externally or internally connected to the loan access evaluation system. For example, the online business system may be an e-commerce website or a banking system that belongs to a different company than the owner of the loan access evaluation system and externally connected thereto through the Internet. Alternatively, the online business system may be an e-commerce website or a financial system that belongs to the same company as the owner of the loan access evaluation system and internally connected thereto through a LAN. The internal online business system and the loan access evaluation system may even be hosted on the same server or a same server cluster. When multiple online business systems are connected to the loan access evaluation system, some may be externally connected and some may be internally connected.

The loan applicant conducts business on the online business system. For example, the online business system may be an online trading platform such as Alibaba.com, an online shopping/auction website such as TaoBao.com, an online payment platform, or an electronic banking system. The loan applicant conducts respective business using the services provided by the online business system. In this disclosure, a loan applicant is typically a company in business.

At Block S102, the loan access evaluation system receives business transaction information of the loan applicant from the connected online business system. The business transaction information contains information of actual business transactions conducted by the loan applicant on or through the online business system. Such information may contain data of individual transactions, or summary data of multiple transactions during a certain period of time. The business transaction information may be received either passively without requiring the loan access evaluation system to send an active request of the business transaction information to the online business system, or actively upon request by the loan access evaluation system. The transmission the business transaction information from the online business system to the loan access evaluation system may be conducted periodically or in real time.

Meanwhile, the loan access evaluation system may collect additional information of the loan applicant using other means from other sources, including information entered by the loan applicant, information collected from financial institutions and financial systems, and information collected from internal information sources and independent information sources. The information of the loan applicant may be collected using various methods. In one embodiment, the additional information of the loan applicant may be collected through an external information collection interface. In another embodiment, the additional information of the loan applicant may be collected through an internal information collection interface. The information of the loan applicant may be actively or passively collected by establishing connections with related electronic systems or platforms.

The collected information of the loan applicant is verified against the information collected on other sources, or cross checked among the regular sources such as the electronically connected online business systems for platforms. A database may be set up using successfully verified information of the loan applicant.

In general, the loan access the evaluation system may receive information of the loan applicant from various electronically connected information sources, such as a website or a system suited for collecting or providing information of loan applicants. Examples of such an electronically connected information source include websites and systems that belong to or are affiliated with Alibaba Group (e.g., TaoBao.com, AliPay, a loan management system of Alibaba.com, etc.), external cooperation platforms or websites (such as various informational websites) and systems (e.g., the credit investigation system of People's Bank of China, and the system of Industrial and Commercial Bank of China), and bank financial platforms (e.g., loan systems, and business transaction systems), etc. As described herein, when the electronically connected information source is an online business system on or through which the loan applicant conducts business, the information of the loan applicant received may contain detailed business transaction data, such as the sales data and information of other business deals or transactions.

At Block S103, the loan access evaluation system analyzes the collected information of the loan applicant to generate an analysis result, which is used as a basis for determining whether the loan applicant satisfies a loan access requirement. The collected information includes at least the received business transaction information of the loan applicant.

This block may verify and validate the information of the loan applicant which has been collected by an external information collection interface or an internal information collection interface as described above. In one embodiment, the loan access evaluation system electronically verifies the collected information of the loan applicant against information from an independent source.

In one embodiment, the collected information of the loan applicant contains data of a plurality of categories each including one or more datan items. These categories may be personal information, company information, and business transaction information, as will be illustrated further below. The loan access evaluation system stores the collected information of the loan applicant in a relational database, which is structured according to the categories and the one or more items under each category.

The analysis result may be in any suitable format generated using an appropriate scheme. In one embodiment, to analyze the collected information of the loan applicant, the loan access evaluation system assigns a category weight to each category and an item weight to each item under each category, and computes a category score of the loan applicant for each category based on the collected information of the loan applicant and the respective category weight and the item weights. The loan access evaluation system may further compute an overall score of the loan applicant based on the category scores. As will be shown in further detail below with examples, the category weights and the item weights may each be a percentage weight allocated in such a way that the sum of all allocated percentage weights make a total of 100%, and the sum of all allocated percentage weights of items under each category make a total of 100%.

The above-mentioned categories each classify multiple items with a common property type for better management of the information. An item refers to a lowest-level factor representing a certain data entry or activity which may include an indicator or a combination of indicators.

Computation of the overall scores is illustrated using an example below, which includes an exemplary addition mode of a hundred-point scale. In this exemplary mode, the sum of all items of the entire summed category is exactly one hundred to represent a whole 100%. The sum of the percentages assigned to all categories is also exactly 100. A percentage of each category is set according to the relevance and importance of the category. An example is given in the following table:

| Points | | | | | User's |
|---|---|---|---|---|---|
| Obtained | | | Content | Assigned | Actual |
| by User | Proportion | Category | (Item) | Proportion | Proportion |
| 8.25 | 55% | Category A | 1st Data | 10% | 5% |
| | | | 2nd Data | 25% | 10% |
| | | | 3rd Data | 5% | 0% |
| | | | 4th Data | 1% | 0% |
| | | | 5th Data | 59% | 0% |
| 21 | 30% | Category B | 6th Data | 50% | 40% |
| | | | 7th Data | 30% | 10% |
| | | | 8th Data | 20% | 20% |
| 15 | 15% | Category C | 9th Data | 100% | 100% |

As shown in the above table, three types or categories of information of the loan applicant, namely category A, B and C, are separately scored for each user. Each category is assigned a proportion 55%, 30% and 15%, respectively, representing the maximum a score point of 55, 30 and 50 for each category respectively. Under each category, multiple datan items are also each assigned a percentage proportion. For example, the three datan items (6th data, 7th data and 8th data) under category B are assigned a proportion of 50%, 30% and 20%, respectively. These percentage proportions are maximum scores a user can earn for each item or category. In practice, the actual proportion earned by or deserved by a loan applicant for each item is less than the assigned proportion. For example, the above exemplary loan applicant's actual proportion for 1st data is 5%, instead of the maximum assigned 10%, meaning that the present loan applicant earns a half (5%/10%=½) of the maximum score for the present item 1st data. Because the maximum score for 1st data is 55×10%=5.5, the present loan applicant earns a 5.5/2=2.75 points from the 1st data. For the entire category A information, the present loan applicant earns 8.25 points, and so on. For all three categories, the present loan applicant earns a total score of 44.25 as can be concluded from the above table.

In the above example, category A, category B and category C information may correspond to the personal information, the company information and the business transaction information of the loan applicant, respectively.

In one embodiment, the loan access evaluation system classifies the loan applicant into one of a plurality of classes using the scores computed above and generates an evaluation report based on the analysis result. For example, the plurality of classes may include the following three classes: temporarily declined, need further cultivation, and immediate follow-up.

The personal information, the company information and the corresponding business transaction information of the loan applicant may be summarized to compute a total score. The loan applicant may be classified into one of classes based on the total score.

At Block S104, the loan access evaluation system disburses a loan to the loan applicant if the score of the loan applicant satisfies the loan requirement (e.g., having been classified as “immediate follow-up” and further satisfied the follow-up process).

By obtaining detailed transaction data of loan applicant (e.g., a company) from e-commerce platforms or systems and banks, the loan access evaluation system of the exemplary embodiments of the present disclosure is able to obtain dynamic business transaction data of the loan applicant in addition to the regular background information such as the personal information of the company's owner and the company background. In addition, the loan access evaluation system can also obtain historical data of the company from loan management systems and/or loan risk control systems that are electronically connected to the loan access evaluation system. This allows a comprehensive analysis of the company loan applicant, and allows the loan process to be completed online, making the operations fast, simple and inexpensive.

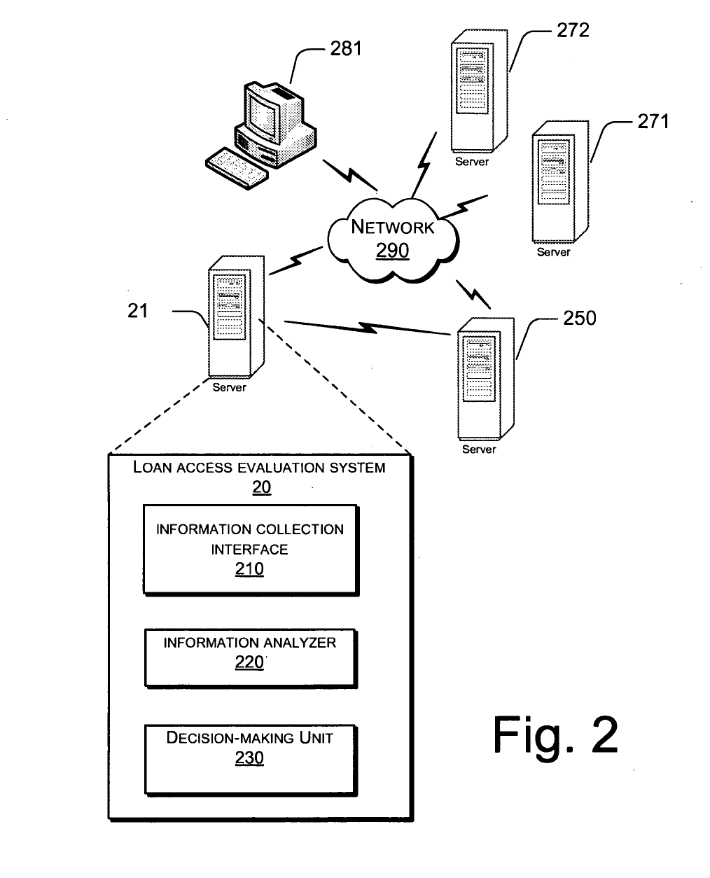

FIG. 2 shows a schematic structural diagram of an exemplary loan access evaluation system in an exemplary environment. Loan access evaluation system 20 is placed in an exemplary network environment for implementing the method of the present disclosure. In one embodiment, the loan access evaluation system 20 is implemented with a computer system 21. The computer system 21 may include one or more servers, or a cluster of servers. For the purpose of illustration, the computer system 21 is connected, either directly or through a LAN, to an internal e-commerce website 250 hosted on another computer system.

The computer system 21 and the loan access evaluation system 20 implemented therein are connected to the external e-commerce website 271 and the external financial institute 272 through network(s) 290. A loan applicant (not shown) may access the loan access evaluation system 20, the internal e-commerce website 250, the external e-commerce website 271 and the external financial institute 272 through network(s) 290.

The computing system 21 may include common computer components such as processor(s), I/O devices, computer readable media, and network interface (not shown). It is also appreciated that a computing system or device may be any device that has a processor, an I/O device and a memory (either an internal memory or an external memory), and is not limited to a personal computer. The computer readable media stores application program modules and data. Application program modules contain instructions which, when executed by processor(s), cause the processor(s) to perform actions of a process described herein. For example, the computer system 21 may be programmed to have an information collection interface 210, an information analyzer 220, and a decision-making unit 230 to perform functions and steps illustrated in FIG. 1.

In the presence disclosure, a “module” or a “unit” in general refers to a functionality designed to perform a particular task or function. A module or a unit can be a piece of hardware, software, a plan or scheme, or a combination thereof, for effectuating a purpose associated with the particular task or function. In addition, delineation of separate units does not necessarily suggest that physically separate devices are used. Instead, the delineation may be only functional, not structural, and the functions of several units may be performed by a single combined device or component. When used in a computer-based system, regular computer components such as a processor, a storage and memory may be programmed to function as one or more units or devices to perform the various respective functions.

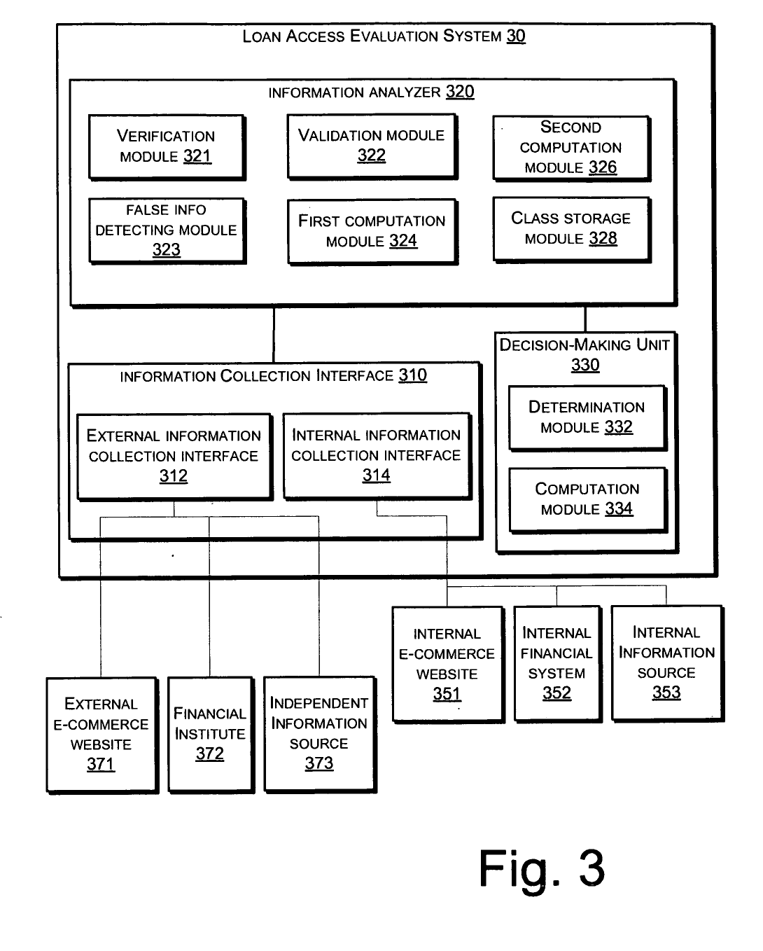

FIG. 3 shows a diagram of an exemplary loan access evaluation system with further detail. The loan access evaluation system 30 includes an information collection interface 310, an information analyzer 320, and a decision-making unit 330.

The information collection interface 310 establishes an electronic connection between the loan access evaluation system 30 and one or more online business systems on or through which a loan applicant conducts business. The online business systems include an external e-commerce website 371 and an external financial institute 372, which are connected through external information collection interface 312. The online business systems also include an internal e-commerce website 351 and an internal financial system 352, which are connected through internal information collection interface 314.

The information collection interface 310 is operative for receiving business transaction information of the loan applicant from the online business systems. The business transaction information contains information of actual business transactions conducted by the loan applicant on or through the online business system.

The information analyzer 320 analyzes collected information of the loan applicant to generate an analysis result as a basis for determining whether the loan applicant satisfies a loan access requirement. The collected information that is being analyzed includes at least the received business transaction information of the loan applicant.

The decision-making unit 330 is adapted for disbursing a loan to the loan applicant if loan requirement is satisfied.

Furthermore, the external information collection interface 312 connects with an independent information source 373, and the internal information collection interface 314 connects with internal information source 353, for actively or passively collecting the information of the loan applicant and verifying the information of the loan applicant. Verifying the collected data information of the loan applicant against various sources improves the accuracy of the information.

The information collection interface 310 also synchronously sets up a database for the information analyzer 320 using successfully verified information of the loan applicant.

The information analyzer 320 may include several modules to perform additional functions. A verification module 311 is used for verifying the information of the loan applicant by applying rules to all data fields as the personal information of the company's owner and the financial and operating information of the company are entered into the evaluation system. The verification helps to correct information that may have been incorrectly or randomly entered by the loan applicant. A validation module 322 is used for validating the information of the loan applicant by analyzing, verifying and checking whether the data is consistent among various sources. The validation module 322 uses algorithms established for internal logical relationships such as financial and operating relationships among various data, and can be adapted for real-time verification. A false info detecting module 323 is used for detecting whether the information of the loan applicant is false or fake by separately collecting certain key information using alternative methods to detect information that may have been forged or falsely provided during applicant information fill-in. For example, multiple questions or filling blocks designed to appear different from each other but really are covering the same information may be used in the same or different questionnaires or data entry forms in order to detect such false information. The exemplary information of a loan applicant is shown in TABLE 1 below.

The information analyzer 320 may further include a first computation module 324 used for separately computing, using the information of the loan applicant, scores of each category and items therein using the weighted proportional values.

Based on various categories of loan applicant information, weighted percentage proportions are set up for each category and each item. When conducting loan evaluation for a loan applicant, a score for each item and a score for each category are computed to evaluate the loan applicant information. The system may modify, add or delete a certain item or category, and may adjust weighted percentage proportions of an item or category anytime as needed. The system may initially use a hundred-point scale by default.

The first computation module 324 may compare the recent data and the historical data of the same applicant, or compare the present data average of an applicant with the data averages of the other applicants. The time periods for collecting recent data and for collecting historical data can be flexibly adjusted.

The loan access evaluation system 30 may implement a great deal of flexibility in the computation algorithms. For example, different algorithms may be used for different types of loan applicants. The algorithm may be adjusted not only from industry to industry, but from applicant to applicant within the same industry (e.g., based on the applicant's business patterns). The loan access evaluation system 30 may set up a unified algorithm for all items under a certain category for some or all applicants, or use a different computing algorithm for different items under the same category.

Upon logging onto the loan access evaluation system 30, an operator may enter into weights management, with all category names and respective weighted percentage proportions listed. An input field with a certain data format (e.g., xx.xx) may be available for editing the present percentage weight of a category. The system may require that the sum of the percentage values of all categories and the sum of the percentage values of all items under each category be exactly one hundred, and may indicate an error if this condition is not satisfied.

Any activity or data created on the Internet by the loan applicant, and any activity or data of the loan applicant associated with an online business system such as a third-party business or trading platform may be used as an item, and may be collected into the loan access evaluation system 30. The category and weights management as shown in TABLE 2 are used for such data collection and may be adjusted anytime as needed. A method using a hundred-point scale may reverse-compute a percentage proportion of a directory or an item that has already been set up. Alternatively, the loan access evaluation system 30 may directly set a separate score value without using a percentage proportion for a certain item.

An exemplary score rule is given below in TABLE 2.

TABLE 2
Score Rule
Score Rule

| | | | | | User of | User |
|---|---|---|---|---|---|---|
| | | | | | Same | within |
| | | | | Self | Business | Same |
| Ratio | Type | Content | Proportion | Comparison | Type | Region |
| ? % | Customer | Number of customers | ? % | | | |
| | Activities | placing an order | | | | |
| | | Relevancy of instant | ? % | | | |
| | | messaging tool | | | | |
| | | Number of visitors the | ? % | | | |
| | | company's website | | | | |
| | | Number of clicks for | ? % | | | |
| | | viewing company's | | | | |
| | | contact method | | | | |
| | | Number of customers | ? % | | | |
| | | viewing the business | | | | |
| | | information of the | | | | |
| | | company | | | | |
| | | Browsing volume of | ? % | | | |
| | | electronic business | | | | |
| | | platform | | | | |
| | | Region where | ? % | | | |
| | | feedback is received | | | | |
| | | Region of visiting | ? % | | | |
| | | customer | | | | |
| ? % | Membership | Tenure term of | ? % | | | |
| | | member of Alibaba | | | | |
| | | International | | | | |
| | | Tenure term of | ? % | | | |
| | | member of Alibaba | | | | |
| | | China | | | | |
| | | Is other type of | ? % | | | |
| | | member | | | | |
| ? % | Sales | Number of repeated | ? % | | | |
| | Activities | business messages | | | | |
| | | Number of newly sent | ? % | | | |
| | | business messages | | | | |
| | | Feedback to purchase | ? % | | | |
| | | request | | | | |
| | | View purchase request | ?% | | | |
| | | Number of valid | ? % | | | |
| | | business messages | | | | |
| | | Operating condition of | ? % | | | |
| | | management platform | | | | |
| | | (basic version) | | | | |
| | | Number of product | ? % | | | |
| | | promotions | | | | |
| | | Amount spent on | ? % | | | |
| | | promoting products | | | | |
| | | Operating condition of | ? % | | | |
| | | management platform | | | | |
| | | (advanced version) | | | | |
| ? % | Management | Number of days | ? % | | | |
| | Activities | instant messaging tool | | | | |
| | | is logged in last week | | | | |
| | | Number of days | ? % | | | |
| | | website is logged in | | | | |
| | | for a management last | | | | |
| | | week | | | | |
| | | Online duration of | ? % | | | |
| | | instant messaging tool | | | | |
| | | last week | | | | |
| | | Increase in degree of | ? % | | | |
| | | activity of instant | | | | |
| | | messaging tool last | | | | |
| | | week | | | | |
| ? % | Online | Amount of online | ? % | | | |
| | Payment | payments | | | | |
| | | Number of online | ? % | | | |
| | | payments | | | | |
| | | Amount of online | ? % | | | |
| | | transaction orders | | | | |
| | | Number of online | ? % | | | |
| | | transaction orders | | | | |

Furthermore, the first computation module 324 analyzes the comprehensive information of a loan applicant by computing scores of the company in various aspects of the business, finance and production indicators. The comprehensive information of the company may include economic indicators of operating technology, analyses of investment ability, future operating revenues, conditions of assets and liabilities, and analyses of existing cash flow of the company. TABLES 3-7 show an example of a company's comprehensive information that may be collected and analyzed by the loan access evaluation system 30.

TABLE 3
Economic Indicators of Company Operating Technology

| | | | Year | | Increase |
|---|---|---|---|---|---|
| | | | 2xxx | | From Year |
| | | | (Year | Year | Before Last |
| | | | Before | 2xxx | Year to |
| Serial | | | Last | (Last | Last Year |
| Number | Item Name | Unit | Year) | Year) | (%) |
| 1 | Design Ability | | | | |
| 2 | Production Volume | | | | |
| 3 | Loan Rate | % | | | |
| 4 | Sales Volume | | | | |
| 5 | Ratio of Production | % | | | |
| | to Sales | | | | |
| 6 | Operating | | | | |
| | Efficiency | | | | |
| 7 | Average Price | | | | |
| 8 | Revenue of Primary | In Ten | | | |
| | Business | Thousand | | | |
| | | Dollars | | | |
| 9 | Profit of Primary | In Ten | | | |
| | Business | Thousand | | | |
| | | Dollars | | | |
| 10 | Total Profit | In Ten | | | |
| | | Thousand | | | |
| | | Dollars | | | |
| 11 | Net Profit | In Ten | | | |
| | | Thousand | | | |
| | | Dollars | | | |
| 12 | Interest Paid | In Ten | | | |
| | | Thousand | | | |
| | | Dollars | | | |
| 13 | Gross Investment | In Ten | | | |
| | | Thousand | | | |
| | | Dollars | | | |
| 14 | Net Yield of Gross | % | | | |
| | Investment | | | | |

TABLE 4
Analysis of Company Investment Ability

| | | Item That | Item That |
|---|---|---|---|
| | | May Use | Requires to |
| Serial | | Existing | Use Existing |
| Number | Item Name | Assets | Assets |
| 1 | Company's Existing Capital in cash | | |
| | (1.1-1.2) | | |
| 1.1 | Capital in cash | | |
| 1.2 | Cash circulated | | |
| 2 | Company's Future Operating | | |
| | Revenue | | |
| 3 | Company's Realizable Assets | | |
| | (3.1-3.2) | | |
| 3.1 | Possible Realizable Assets | | |
| 3.1.1 | Short-term Investment | | |
| 3.1.2 | Dividend Receivable | | |
| 3.1.3 | Interest Receivable | | |
| 3.1.4 | Allowable Receivable | | |
| 3.1.5 | One-year Investment Bonds | | |
| 3.1.6 | Other Liquid Assets | | |
| 3.1.7 | Long-term Investment | | |
| 3.2 | Dividend Payable | | |
| 4 | Balance of Abandoned Assets | | |
| | Recovered | | |
| 5 | Total (1 + 2 + 3 + 4) | | |

TABLE 5
Analysis of Company's Future Operating Revenue

| Serial | | Year | Year | | | Annual |
|---|---|---|---|---|---|---|
| Number | Item | 2xxx | 2xxx | . . . | Total | Average |
| 1 | Net Cash Flow of | | | | | |
| | Operating Activities | | | | | |
| 2 | Repayment Fund | | | | | |
| 2.1 | Various Interests Paid | | | | | |
| 2.2 | Debt Principal Repaid | | | | | |
| 3 | Company's Future | | | | | |
| | Operating Revenue | | | | | |

TABLE 6
Conditions of Company's Assets and Liabilities

| | | | Year | Year |
|---|---|---|---|---|
| | | Year 2xxx | 2xxx | 2xxx |
| Serial | | (Year Before | (Last | (Current |
| Number | Item | Last Year) | Year) | Year) |
| 1 | Assets | | | |
| 1.1 | Liquid Assets | | | |
| | Monetary Capital | | | |
| | Notes Receivable | | | |
| | Net Receivables | | | |
| | Advanced Payment | | | |
| | Inventory | | | |
| | Deferred Expenses | | | |
| | Other Liquid Assets | | | |
| 1.2 | Fixed Assets | | | |
| | Net Fixed Assets | | | |
| | Project under Construction | | | |
| 1.3 | Intangible and Other Assets | | | |
| 1.4 | Long-term Investment | | | |
| 2 | Liabilities and Owner's Equity | | | |
| 2.1 | Current Liabilities | | | |
| | Short-term Loan | | | |
| | Account Payable | | | |
| | Deposit Received | | | |
| | Other Account Payable | | | |
| | Other Liabilities | | | |
| 2.2 | Long-term Liabilities | | | |
| | Long-term Loan | | | |
| | Other Long-term Liabilities | | | |
| | Total Liabilities | | | |
| 2.3 | Owner's Equity | | | |
| | Paid-in Capital | | | |
| | Capital Reserve | | | |
| | Surplus Reserves | | | |
| | Undistributed Profit | | | |
| | Asset-liability Ratio (%) | | | |
| | Liquidity Ratio (%) | | | |
| | Quick Ratio (%) | | | |
| | Cash Ratio (%) | | | |

TABLE 7
Analysis of Company's Existing Cash Flow

| | | Year 2xxx | | |
|---|---|---|---|---|
| Serial | | (Year Before | Year 2xxx | |
| Number | Item | Last Year) | (Last Year) | Remarks |
| 1 | Net Cash Flow of | | | |
| | Operating Activities | | | |
| 1.1 | Cash Inflow | | | |
| 1.1.1 | Sales (Operating) | | | |
| | Revenue | | | |
| 1.1.2 | VAT on Sales | | | |
| 1.1.3 | Subsidy Revenue | | | |
| 1.1.4 | Other Revenues | | | |
| 1.2 | Cash Outflow | | | |
| 1.2.1 | Operating Cost | | | |
| 1.2.2 | Withholdings on VAT | | | |
| 1.2.3 | Sales Tax | | | |
| 1.2.4 | VAT | | | |
| 1.2.5 | Income Tax | | | |
| 1.2.6 | Other Outflows | | | |
| 2 | Net Cash Flow of | | | |
| | Investment Activities | | | |
| 2.1 | Cash Inflow | | | |
| 2.1.1 | Balance of Fixed | | | |
| | Assets Recovered | | | |
| 2.1.2 | Recovered Circulating | | | |
| | Fund | | | |
| 2.1.3 | Investment Yield | | | |
| 2.2 | Cash Outflow | | | |
| 2.2.1 | Construction | | | |
| | Investment | | | |
| 2.2.2 | Investment for | | | |
| | Updating Equipment | | | |
| 2.2.3 | Investment for Liquid | | | |
| | Assets | | | |
| 2.2.4 | Others | | | |
| 3 | Net Cash Flow of | | | |
| | Capital Raising | | | |
| | Activities | | | |
| 3.1 | Cash Inflow | | | |
| 3.1.1 | Equity Input | | | |
| 3.1.2 | Loan for Construction | | | |
| | Investment | | | |
| 3.1.3 | Loan for Circulating | | | |
| | Fund | | | |
| 3.1.4 | Bonds | | | |
| 3.1.5 | Account Payable | | | |
| 3.1.6 | Short-term Loan | | | |
| 3.1.7 | Others | | | |
| 3.2 | Cash Outflow | | | |
| 3.2.1 | Various Interests Paid | | | |
| 3.2.2 | Debt Principal Repaid | | | |
| 3.2.3 | Profit Payable | | | |
| | (Dividend | | | |
| | Distribution) | | | |
| 3.2.4 | Others | | | |
| 4 | Net Cash Flow | | | |
| | (1 + 2 + 3) | | | |
| 5 | Cumulative | | | |
| | Surplus Fund | | | |

In addition, personal information of the applicant or the owner of the company applicant may also be collected as follows.

| | |
|---|---|
| Name | Number of Household Members |
| Age | Spouse's Age |
| Gender | Spouse's Academic Qualifications |
| Academic Qualifications | Spouse's Work Experience |
| Work Experience | Spouse's Identification Card Number |
| Average Monthly Personal Income | Estimated Annual Household Income |
| Average Annual Personal Income | Total Household Properties |
| Identification Card Number | Number of Children |
| Permanent Residence | |
| Current Residence | |
| Personal Property | |
| Have Bank Mortgage Loan | |
| Number of Credit Cards | |

The information analyzer 320 is further used for classifying the loan applicant into one of a plurality of classes and generating an evaluation report, based on the analysis result generated by the information analyzer 320. To do this, a second computation module 326 is used for summarizing the scores of various categories to compute an overall score of the loan applicant. The second computation module 326 may further classify the loan applicant into one of the several classes (e.g., temporarily declined, need further cultivation, and immediate follow-up) based on the computed overall score. The computed scores and classification may be stored in a storage module 328.

The decision-making unit 330 is used for disbursing a loan to the loan applicant if loan requirement is satisfied, based on the evaluation report generated by the information analyzer 320. Moreover, the decision-making unit 330 may include several additional modules. A determination module 332 is used for determining whether the loan will be disbursed to the loan applicant based on the class of the loan applicant classified by the information analyzer 320. A computation module 334 is used for automatically computing a loan amount, a loan term, and an interest affordable by the loan applicant based on historical business operation data and earnings of the loan applicant upon determining that a loan is allowed to be disbursed to the loan applicant.

The above loan access evaluation system 30 may further include other electronically connected information sources such as independent information source 373 and internal information source 353, which are used for providing additional information of the loan applicant, and for verifying or cross check-checking the information.

The foregoing modules may be deployed within a single device, or may be distributed among multiple devices. The foregoing modules may be combined into a single module, or may further be divided into a number of sub-modules.

The disclosed method and system may be implemented using hardware, or can be implemented using software installed on universal or commodity hardware. For example, the algorithms and technical schemes of the present disclosure may be implemented in the form of software products which are stored in a non-volatile storage media (e.g., CD-ROM, U drive, or portable hard drive). The software includes instructions for a computing device (e.g., a personal computer, a server or a networked device) to execute the method described in the exemplary embodiments of the present disclosure.

It is appreciated that some exemplary modules or processes described in the accompanying figures may not be required for implementation of the present disclosure. The exemplary modules may be deployed into an exemplary device according to the exemplary embodiments, or may be placed among multiple exemplary devices of several exemplary embodiments. The modules in the foregoing exemplary embodiments may be combined into a single module, or may further be divided into a number of sub-modules.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method for evaluating loan access, the method comprising:
establishing an electronic connection between a loan access evaluation system and at least one online business system on or through which a loan applicant conducts business;
at the loan access evaluation system, receiving business transaction information of the loan applicant from the at least one online business system, the business transaction information containing information of actual business transactions conducted by the loan applicant on or through the online business system;
analyzing collected information of the loan applicant to generate an analysis result as a basis for determining whether the loan applicant satisfies a loan access requirement, the collected information including at least the received business transaction information of the loan applicant; and
disbursing a loan to the loan applicant if the loan requirement is satisfied.

2. The method as recited in claim 1, wherein the at least one online business system includes an online business system externally connected to the loan access evaluation system.

3. The method as recited in claim 1, wherein the at least one online business system includes an online business system internally connected to the loan access evaluation system.

4. The method as recited in claim 1, wherein the at least one online business system includes one or more of an e-commerce website and a banking system.

5. The method as recited in claim 1, wherein receiving business transaction information is conducted passively without requiring the loan access evaluation system to send an active request of the business transaction information to the online business system.

6. The method as recited in claim 1, further comprising:
electronically verifying the collected information of the loan applicant against information from an independent source.

7. The method as recited in claim 1, wherein the collected information of the loan applicant contains data of a plurality of categories each including one or more items.

8. The method as recited in claim 7, further comprising:
storing the collected information of the loan applicant in a relational database, wherein the database is structured according to the plurality of categories and the one or more items under each category.

9. The method as recited in claim 7, wherein analyzing the collected information of the loan applicant comprises:
assigning a category weight to each category and an item weight to each item under each category; and
computing a category score of the loan applicant for each category based on the collected information of the loan applicant and the respective category weight and the item weights.

10. The method as recited in claim 9, wherein analyzing the collected information of the loan applicant further comprises:
computing an overall score of the loan applicant based on the category scores.

11. The method as recited in claim 9, wherein the category weights and the item weights are each an allocated percentage weight, the sum of all allocated percentage weights making a total of 100% and the sum of all allocated percentage weights of items under each category making a total of 100%.

12. The method as recited in claim 7, wherein the plurality of categories comprises:
personal information, company information, and business transaction information.

13. The method as recited in claim 1, further comprising:
classifying the loan applicant into one of a plurality of classes according to the analysis result.

14. The method as recited in claim 13, wherein the plurality of classes comprises:
temporarily declined, need further cultivation, and immediate follow-up.

15. The method as recited in claim 1, wherein disbursing the loan to the loan applicant if the loan requirement is satisfied comprises:
automatically computing a loan amount, a loan term, and an interest affordable by the loan applicant based on historical business operation data.

16. A loan access evaluation system, the system comprising:
an information collection interface establishing an electronic connection between the loan access evaluation system and at least one online business system on or through which a loan applicant conducts business, the information collection interface being operative for receiving business transaction information of the loan applicant from the online business system, the business transaction information containing information of actual business transactions conducted by the loan applicant on or through the online business system;
an information analyzer analyzing collected information of the loan applicant to generate an analysis result as a basis for determining whether the loan applicant satisfies a loan access requirement, the collected information including at least the received business transaction information of the loan applicant; and
a decision-making unit adapted for disbursing a loan to the loan applicant if loan requirement is satisfied.

17. The loan access evaluation system as recited in claim 16, wherein the at least one online business system includes an online business system externally connected to the loan access evaluation system.

18. The loan access evaluation system as recited in claim 16, wherein the at least one online business system includes an online business system internally connected to the loan access evaluation system.

19. The loan access evaluation system as recited in claim 16, wherein the at least one online business system includes one or more of an e-commerce website and a banking system.

20. The loan access evaluation system as recited in claim 16, wherein the collected information of the loan applicant contains data of a plurality of categories each including one or more items, the system further comprising:
a database storing the collected information of the loan applicant, the database being structured according to the plurality of categories and the one or more items under each category.
